(19) United States
(12) Patent Application Publication
(10) Pub. No.: US 2011/0180186 A1
(43) Pub. Date: Jul. 28, 2011

(54) METHOD AND SOLUTION FOR COATING METALLIC SURFACES WITH A PHOSPHATING SOLUTION CONTAINING HYDROGEN PEROXIDE, METALLIC OBJECT PRODUCED AND USE OF THE OBJECT

(76) Inventors: Thomas Nitschke, Friedrichsdorf (DE); Rudiger Rein, Breidenbach (DE); Eckart Schönfelder, Idstein (DE); Peter Schubach, Nidderau/Windecken (DE); Jürgen Specht, Rodgau (DE)

(21) Appl. No.: 13/081,823

(22) Filed: Apr. 7, 2011

Related U.S. Application Data
(63) Continuation of application No. 10/555,929, filed on Jan. 17, 2006.

(30) Foreign Application Priority Data
May 23, 2003 (DE) 103 23 305.9

(51) Int. Cl. C23C 22/07; B32B 15/04

(52) U.S. Cl. 148/260; 148/400

(57) ABSTRACT

A method for the treatment or pre-treatment of surfaces of metal objects by means of an acidic, aqueous solution containing zinc and phosphate. The phosphating solution contains between 0.1-10 g/L, zinc, 4-50 g/L phosphate calculated as PO₄, between 0.03-3 g/L, of at least one guanidine compound comprising at least one nitro group calculated as nitroguanidine, and between 0.001-0.9 g/L hydrogen peroxide and has a temperature of less than 80° C. The corresponding acidic, aqueous composition and finished products are also disclosed.

The invention relates to a process for coatiilg metallic surfaces with a phosphating solution which contains both hydrogen peroxide and also at least one guanidine compound, such as nitroguanidine, the corresponding phosphating solution and the use of the objects coated by the process according to the invention.

The formation of phosphate layers on metallic objects has been used for decades with quite different compositions. These coatings primarily serve as protection from corrosion and to increase the adhesive strength of a subsequent layer, such as e.g. a lacquer layer. The phosphate layer here often has a layer thickness in the range from 1 to 30 μm.

Phosphate coatings are widely used as corrosion protection layers, as an adhesive base for lacquers and other coatings and optionally as a shaping aid under a subsequently applied lubricant layer for cold shaping or also as a coating for adjusting the torque of special screws for automated screwing. Above all if the phosphate coatings are used as protection for a short time, in particular during storage, and are then e.g. lacquered, they are called a pretreatment layer before lacquering. However, if no lacquer layer and no other type of organic coating follows the phosphate coating, treatment is referred to instead of pretreatment. These coatings are also called conversion layers if at least one cation is dissolved out of the metallic surface, that is to say the surface of the metallic object, and is co-used for building up the layer.

Coating of metallic surfaces with phosphate layers can be carried out in diverse ways. Zinc-, manganese- or/and nickel-containing phosphating solutions are often employed here. Some of the metallic substrates to be coated on their surface in the baths or installations can also have a content of aluminium or aluminium alloys, which may possibly lead to problems. The phosphate layer(s) should usually have, together with at least one subsequently applied lacquer layer or lacquer-like coating, a good corrosion protection and a good lacquer adhesion. If more than one phosphate layer is applied, pre- and after-phosphating are usually referred to. Simultaneous phosphating of substrates with different metallic surfaces has increased in importance. In particular, the content of aluminium-containing surfaces in such systems is increasing, so that problems occur during phosphating in such systems more readily and more often than previously,

Because of the toxicity and incompatibility with the environment, increased heavy metal contents, such as e.g. of nickel, in the phosphating solution, which lead to unavoidable high heavy metal contents in the waste water, in the phosphate sludge and in the grinding dust, are less acceptable. There are therefore numerous set-ups for working with nickel-free or at least. lower-nickel phosphating solutions. However, these phosphating solutions have not yet hitherto become widely accepted, but often still show significant disadvantages in comparison with the nickel-rich phosphating processes. When phosphating was hitherto carried out with low contents of nickel in the automobile industry, problems occasionally occurred with a varying lacquer adhesion, so that these studies were not continued. Furthermore, the aim is also to avoid toxic heavy metals, such as e.g, cadmium and chromium, even in small amounts,

In zinc, phosphating, acceleration by nitrate and nitrite is often chosen, In some cases only nitrate needs to be added here, since a low nitrite content is also formed from this independently via a redox reaction. Such phosphating systems are often good and inexpensive. The phosphating systems with nitrate or/and nitrite additions are particularly preferred for aluminium-rich surfaces in particular. However, such phosphating systems have the disadvantage that the high contents of nitrate used here are usually kept at a level of about 3 to 15 g/l of nitrate and thereby very severely pollute the waste water. Because of stricter environmental requirements, there is the need to decrease troublesome contents of the waste water as much as possible or to treat them by expensive chemical means.

On the other hand, zinc-rich phosphating solutions which contain only hydrogen peroxide as an accelerator are known. For environment-friendliness reasons alone, the accelerator hydrogen peroxide is ideal, since only water is formed from hydrogen peroxide, However, it is also known that zinc phosphating by the dipping process often leads to very thin phosphate layers on the surfaces of steel and other iron-based materials if hydrogen peroxide alone is employed as the accelerator, a blue interference colour often being found here. Instead of the so-called layer-forming phosphating, which forms somewhat thicker phosphate layers than the so-called non-layer-forming phosphating and which is conventionally used in zinc phosphating, the conditions of non-layer-forming phosphating are then established. Details of this can he found in Werner Rausch: Die Phosphatierung von Metallen [Phosphating of Metals], Saulgau 1988 (see in particular pages 109-118). Such layers usually have layer thicknesses of up to about 0.5 μm or layer weights of up to about 1 g/m². Such phosphate layers are of inadequate quality for many intended uses, in particular in respect of their corrosion resistance. The phosphate layers which have been prepared solely with the accelerator hydrogen peroxide show relatively large phosphate crystals, so that comparatively rough, non-uniform and uneven phosphate layers are formed. Tabular phosphate crystals often arise here. Even in the best phosphating systems accelerated with hydrogen peroxide, it was not possible for an average edge length of the phosphate crystals of less than 10 μm to be reliably maintained. Smaller phosphate crystals than in these phosphating systems are therefore preferred in the phosphate layers.

On the other hand, several publications describe zinc phosphating solely with nitroguanidine. No phosphate layers which are too thin are formed by this means on steel. The average edge length of the phosphate crystals often lies in the range from about 5 to 20 μm and thereby renders possible fine-grained, uniform, even phosphate layers and a softer sludge which is readily removed, However, zinc phosphating solely with this accelerator has the disadvantage that comparatively high, concentrations of nitrogpanidine—sometimes even in the range from 0.5 to 3 g/l—are to he employed, that nitroguanidine can be determined sufficiently accurately in the phosphating solution only with an expensive analysis, such as e.g. HPLC, that at a content. of at least about 2.8 g/l in the phosphating solution nitroquanidine can crystallize out. on cooling to less than about 30° C. and then becomes concentrated unused in the sludge and possibly is also deposited on the metallic surfaces to be phosphated and can lead to lacquer defects, and that the consequently increased contents of this comparatively expensive accelerator lead to significantly higher raw material costs, since nitraguanidine is by far the most expensive component in phosphating,

A phosphating temperature in the range from about 48 to 60° C. is conventionally necessary in these abovementioned phosphating systems.

DE-C3 23 27 304 mentions, as an accelerator for application of zinc phosphate coatings to metallic surfaces, hydrogen peroxide, in particular with a content of 0.03 to 0.12 g/l in the phosphating solution,

DE-C2 27 39 006 describes a process for the surface treatment of zinc or zinc alloys with an aqueous, acidic, nitrate- and ammonium-free phosphating solution which contains a high content of nickel or/and cobalt and 0.5 to 5 g/l of hydrogen peroxide and optionally also boron fluoride or free fluoride, The examples mention zinc phosphating solutions which have, in addition to a content of 2 to 6.2 g/l of nickel or/and 1 to 6.2 q/l of cobalt, 1,1 or 2 g/l of hydrogen peroxide and in some cases additionally also a content of 4.5 g/l of boron fluoride.

EP-B1 0 922 123 protects aqueous phosphate-containing solutions for producing phosphate layers on metallic surfaces, which contain phosphate, 0.3 to 5 g/l of zinc and 0.1 to 3 g/l of nitroguanidine. The examples have a nitroguanidine content of 0.5 or 0.9 g/l.

The doctrine of DE-A1 101 18 552 is a zinc phosphating process in which one or more accelerators chosen from chlorate, nitrite, nitrobenzenesulfonate, nitrobenzoate, nitrophenol and compounds based on hydrogen peroxide, hydroxylamine, reducing sugar, organic N oxide such as e.g, N-methylmorpholine, and organic nitro compound such as e.g, nitroguanidine, nitroarginine and nitro-furfurylidene diacetate, can be employed. The content of such organic nitro compounds in the phosphating solution, only as long as no other accelerators are employed, can be in the range from 0.5 to 5 g/l.

It has been found in these abovementioned and in similar publications that either hydrogen peroxide or nitroguanidine is used for zinc phosphating or a choice from a very large number of accelerators is referred to,

Nevertheless, however, none of the publications inspected has aiven an example here in which hydrogen peroxide and nitroguanidine are employed simultaneously as the accelerator.

DB-C 977 533 describes, in the embodiment examples, zinc phosphate solutions which, starting from primary zinc phosphate, Zn(H₂PO₄)₂, simultaneously comprise on the one hand nitroguanidine or at least one other nitrogen-containing accelerator and on the other hand hydrogen peroxide, The concentration of the organic accelerator or accelerators in the phosphating bath should be kept constantly above 1 g/l. The examples are evidently based on an initial composition of about 13.5 g/l of zinc, 38 g/l of PO₄ and in example 1 on 2 g/l of nitroauanidine and 2 g/l of hydrogen peroxide, in example 2 on 1 g/l of nitroguanidine and 2 g/l of H₂O₂, in example 3 on 3 g/l of nitroguanidine and 1 g/l of H₂O₂ and in example 4 on 2.3 g/l of nitroguanidine and a high hydrogen peroxide content which is not stated in more detail. Unusually high temperatures, 85 and 95° C., are used here. However, when the operating temperature was lowered to 60° C., a time of 10 minutes, which is already unacceptable for current conditions, was required for the phosphating. The mean of the consumption mentioned in this patent specification is about four time as high as in the process according to the invention of this Application in respect of hydrogen peroxide, and about thirty-six times as high as in the process according to the invention in respect of nitroguanidine.

The subject. matter of the patent application DE 103 20 313 is expressly included in this Application, in particular in respect of the compositions, process steps, embodiment examples and uses,

There was therefore the object of providing a process for phosphating of metallic surfaces in which the nitrogen load of waste waters of the phosphating can be kept particularly low and which is also suitable for coating surfaces containing low and high contents of aluminium, The phosphate layer formed here should be closed, of fine-grained crystallinity (average edge length less than 20 μm) and, in at least some of the compositions, of sufficiently high corrosion resistance and sufficiently good lacquer adhesion. It should be possible to employ the process as easily and reliably as possible.

It has been found, surprisingly, that by the addition of nitroguanidine to a phosphating solution containing hydrogen peroxide, the phosphate layer thicknesses are formed. in a significantiv thicker and more corrosion-resistant manner. Layer weights in particular in the range from 1.5 to 3 g/m² are formed by this means on surfaces of iron-based materials, layer weights in particular in the range from 1 to 6 g/m² on surfaces of aluminium-rich materials, and layer weights in particular in the range from 2 to 6 g/m² on surfaces of zinc-rich materials. When brought into contact with the phosphating solution by spraying or/and dipping, 0.8 to 8 g/m² are usually achieved here. by rolling on and drying on—in the so-called no-rinse process—such as e.g. in the belt process, even far thicker phosphate layers can he achieved.

Conversely, it has been found that by the addition of hydrogen peroxide to a phosphating solution containing nitroguanidine, the phosphate layers were formed. significantly less expensively for the same quality of the phosphating process and the phosphate layers. It was possible to combine the advantages of nitroguanidine and hydrogen peroxide by this means.

The object is achieved by a process for the treatment or pretreatment of surfaces of metallic objects—such as e.g. of components, profiles, strips or/and wires with metallic surfaces, in which optionally at least a portion of these surfaces can consist of aluminium or/and at least one aluminium alloy, and optionally the further metallic surfaces can. consist predominantly of iron alloys, zinc or/arid zinc alloys—with an acidic, aqueous solution containing zinc and phosphate, in which the phosphating solution contains
0.1 to 10 g/l of zinc,
4 to 50 g/l of phosphate, calculated as PO₄,
0.03 to 3 g/l of at least one guanidine compound which contains at least one nitro group, calculated as nitroguanidine, and
0.001 to 0.9 g/l of hydrogen peroxide and has a temperature of less than 80°C.,

It has been found, surprisingly, that the simultaneous presence of at least one guanidine compound which contains at least one nitro group, such as e,g. nitroguanidine, and of hydrogen peroxide in the phosphating solution has a particularly advantageous effect of the raw material. consumption, raw material costs, layer formation and sludge formation, It was furthermore surprising here that it is even possible to achieve high-quality coating results with comparatively low contents of guanidine compound(s) and hydrogen peroxide.

The acidic, aqueous composition, which is called here, inter ilia, phosphating solution, and also the associated corresponding concentrate and the associated topping-up solution, can be a solution or a suspension, since the precipitation products from the solution which are necessarily formed form a suspension if a certain content of precipitation products are suspended,

The phosphating solution preferably contains at least 0.2 g/l or 0.3 g/l of zinc, particularly preferably at least 0.4 g/l, very particularly preferably at least 0.5 g/l, in particular in some situations at least. 0.8 g/l, in some cases at least 1.2 g/l, at least 1.7 g/l, at least 2.4 g/l or even at least 4 g/l. It preferably contains up to 8 g/l of zinc, particularly preferably up to 6.5 g/l, very particularly preferably up to 5 g/l, in particular in some situations up to 4 g/l, above all up to 3 g/l or up to 2 g/l.

The phosphating solution preferably contains at least 5 g/l of phosphate, particularly preferably at least 7 g/l, very particularly preferably at least 10 g/l, in particular in some situations at least 14 g/l, at least 18 g/l, at least 24 g/l or even at least 30 g/l. It preferably contains up to 40 g/l of phosphate, particularly preferably up to 35 g/l, very particularly preferably up to 30 g/l, in particular in some situations up to 25 g/l, above all up to 20 g/l or up to 15 g/l. The ratio of zinc to phosphate can preferably be kept in the range from 1:40 to 1:4, particularly preferably in the range from 1:30 to 1:5, very particularly preferably in the range from 1:20 to 1:6.

The contents of zinc and phosphate can greatly depend here on the desired concentration level, but in some cases also on the content of other cations, such as e.g. of Mn or/and Ni, In particular, the contents of zinc or zinc and manganese can be correlated with the contents of phosphate, Both the ratio of the total content of zinc and manganese to phosphate and the ratio of the total content of zinc, manganese and nickel to phosphate can preferably be kept in the range from 1:40 to 1:3, particularly preferably in the range from 1:30 to 1:3.5, very particularly preferably in the range from 1:20 to 1:4.

The phosphating solution preferably contains at least 0.03 g/l of at least one guanidine compound containing at least one nitro group, such as e.g. nitroguanidine, or/and at least one alkyinitroguanidine, particularly preferably at least 0.05 g/l, very particularly preferably at least 0.07 g/l, in particular at least 0.09 g/l or even at least 0.12 g/l. It preferably contains up to 2.5 g/l, particularly preferably up to 2 g/l, very particularly preferably up to 1.5 g/l, in particular up to 1.2 g/l, above all up to 0.8 g/l or up to 0.5 g/l of at least one guanidine compound containing at least one nitro group,

Alkyinitroauanidines which can be employed are e.g. methylnitroguanidine, ethylnitroguanidine, butylnitroguanidine or/and propylnitroguanidine, Aminoguanidine is preferably formed from nitroguanidine by this means. The at least one nitro group (NO₂) of guanidine compound(s) is converted into at least one amino group (NH₂) in the context of a redox reaction. The accelerator acts as an oxidizing agent by this means, The phosphating solution according to the invention should contain substantially no nitrite because of the potent oxidizing agent, and. it should therefore also be possible for substantially no nitrous gases (NO) to be formed.

The phosphating solution preferably contains at least 0.001 g/l of hydrogen peroxide, particularly preferably at least 0.003 g/l, very particularly preferably at least 0.005 g/l, in particular in some situations at least 0.01 g/l, at least 0.05 g/l, at least 0.1 g/l, at least 0.15 g/l or even at least 0.2 g/l. It preferably contains up to 0.9 g/l of hydrogen peroxide, particularly preferably up to 0.8 g/l, very particularly preferably up to 0.7 a/l, in particular in some situations up to 0.5 g/l, above all up to 0.3 g/l or up to 0.1 g/l. In the experiments carried out, a content of hydrogen peroxide for example of the order of 0.006 g/l, 0.0075 g/l, 0.009 g/l or 0,011 g/l was particularly advisable. A higher content of this accelerator instead usually did not produce better results. Rather, the consumption. of hydrogen peroxide. also rose in proportion to its content. In the process according to the invention it was possible for the content. of this accelerator to be lowered significantly. in the throughput experiment, it was also possible to keep the hydrogen peroxide content. in the range from 0.01 to 0.4 or even in the range from 0.02 to 0.3 g/l for several days, in spite of discontinuous addition of hydrogen peroxide.

In the phosphating process according to the invention, the contents in the phosphating solution of manganese can be 0.1 to 10 g/l or/and of nickel 0.01 to 1.8 g/l.

It is particularly preferable for the phosphating solution. to contain. at least 0.2 g/l of manganese, particularly preferably at least 0.3 g/l very particularly preferably at least 0.4 g/l, in particular in some situations at least 0.8 g/l, at least 1.5 g/l, at least 3 g/l or even at least 6 g/l. It preferably contains up to 8 g/l of manganese, particularly preferably LID to 6 g/l, very particularly preferably up to 4 g/l, in particular in some situations up to 2.5 g/l, above all up to 1.5 g/l or up to 1 g/l. It is usually advantageous to add manganese.

The ratio of zinc to manganese can be varied within wide ranges. It can preferably also be kept in the ratio of zinc to manganese in the range from 1:20 to 1 : 0.05, particularly preferably in the range from 1:10 to 1:03.1, very particularly preferably in the range from 1:4 to 1:0.2.

A content of nickel in the phosphating bath. may be advantageous in particular when bringing into contact with zinc-containing surfaces. On the other hand a nickel content of the phosphating bath is usually not necessary for aluminium- or/and iron-rich. surfaces. It is particularly preferable for the phosphating solution to contain at least 0.02 g/l of nickel, particularly preferably at least 0.04 g/l, very particularly preferably at least 0.08 g/l or at least 0.15 g/l, in particular in some situations at least 0.2 g/l at least 0.5 g/l, at least 1 g/l or even at least 1.5 g/l. It preferably contains up to 1.8 g/l of nickel, particularly preferably up to 1.6 g/l, very particularly preferably up to 1,3 g/l, in particular in some situations up to 1 g/l, above all up to 0.75 g/l or up to 0.5 g/l.

In the phosphating process according to the invention—in most cases—the contents in the phosphating solution of FE:²⁺ can be 0.005 to 1 g/l or/and of complexed Fe³⁺ 0.005 to 0.5 g/l.

In many cases the composition according to the invention will contain not more than 0.2 g/l of Fe²⁺, because of the content of hydrogen peroxide, and will therefore comprise e.g. 0.01, 0.03, 0.05, 0.08, 0.1, 0.14 or 0.18 g/l. The phosphating solution under certain circumstances can contain, in addition, at least 0.01 g/l of complexed Fe³⁺, particularly preferably at least. 0.02 g/l, very particularly preferably at least 0.03 g/l or at least 0.05 g/l, in particular in some situations at least 0,08 g/l or even at least 0.1 g/l. It preferably contains up to 0.3 g/l of complexed Fe³⁺, particularly preferably up to 0.1 g/l, very particularly preferably up to 0.06 g/l, in particular in some situations up to 0.04 g/l. Noticeable contents of dissolved Fe are often only contained in the phosphating solution if this is or has been brought into contact with iron-based materials. Nevertheless, it may be advantageous to add dissolved Fe³⁺ to the aqueous composition during the phosphating in particular of materials which are not iron-based, because a sludge of better consistency which is looser and easier to rinse off is then formed. Furthermore, Fe²⁺ is a good pickling agent. The process according to the invention is normally not carried out on the iron side, because the Fe contents are not high enough for this.

In the phosphating process according to the invention, the contents in the phosphating solution of sodium can be 0.04 to 20 g/l, of potassium 0.025 to 35 g/l or/and of ammonium 0.01 to 50 g/l, the total of sodium, potassium and ammonium preferably being 0.025 to 70 g/l.

It is particularly preferable for the phosphating solution to contain at least 0.05 g/l of sodium, particularly preferably at least 0.07 g/l, very particularly preferably at least 0.1 g/l or at least 0.15 g/l, in particular in some situations at least 0.3 g/l, at least 0.5 g/l, at least 1 g/l, at least 2 g/l or even at least 4 g/l. It preferably contains up to 15 g/l of sodium, particularly preferably up to 10 g/l, very particularly preferably up to 6 g/l, in particular in some situations up to 4 g/l, above all up to 3 g/l or up to 2 g/l.

It is particularly preferable for the phosphating solution to contain at least 0.05 g/l of potassium, particularly preferably at least 0.07 g/l, very particularly preferably at least 0.1 g/l or at least. 0.15 g/l, in particular in some situations at. least 0.3 g/l, at least 0.5 g/l, at least 1 g/l, at least 2 g/l or even at least 4 g/l. It preferably contains up to 25 g/l of potassium, particularly preferably up to 15 g/l, very particularly preferably up to 8 g/l, in particular in some situations up to 5 g/l, above all up to 3 g/l or up to 2 g/l.

It is particularly preferable for the phosphating solution to contain at least 0.03 g/l of ammonium, particularly preferably at least 0.06 g/l, very particularly preferably at least 0.1 g/l or at least 0.15 g/l, in particular in some situations at least 0.3 g/l, at least 0.5 g/l, at least 1 g/l, at least 2 g/l or even at least 4 g/l. It preferably contains up to 35 g/l of ammonium, particularly preferably up to 20 g/l, very particularly preferably up to 10 g/l, in particular in some situations up to 6 g/l, above all up to 3 g/l or up to 2 g/l.

It is particularly preferable for the phosphating solution. to contain a total content of sodium, potassium and ammonium of at least 0.05 g/l, particularly preferably of at least 0.1 g/l, very particularly preferably at least 0.2 g/l or at. least 0.3 g/l, in particular in some situations at least 0.5 g/l, at least 1 g/l, at least 2 g/l, at least 4 cal or even at least 8 g/l. It contains a total content of sodium, potassium and ammonium preferably of up to 65 g/l, particularly preferably up to 35 g/l, very particularly preferably up to 20 g/l, in particular in some situations up to 10 g/l, above all up to 6 g/l or up to 3 g/l, Sodium, potassium or/and ammonium is advantageously added to the aqueous composition according to the invention if increased aluminium contents occur in the composition. An addition of sodium or/and potassium is preferable to ammonium for environment friendliness reasons.

In the phosphating process according to the invention, the contents in the phosphating solution of nitrate can be preferably 0.1 to 30 g/l, of chloride preferably 0.01 to 0.5 g/l or/and of sulfate preferably 0.005 to 5 g/l.

On the one hand the phosphating process according to the invention can be operated largely or completely free from nitrate. On the other hand it may be particularly preferable for the phosphating solution to contain at least 0.3 g/l of nitrate, particularly preferably at least 0.6 g/l, very particularly preferably at least 1 g/l or at least 1.5 g/l, in particular in some situations at least 2 g/l, at least. 3 g/l, at least 4 g/l, at least 6 g/l or even at least 8 g/l. It preferably contains up to 22 g/l of nitrate, particularly preferably up to 15 g/l, very particularly preferably up to 10 g/l, in particular in some situations up to 8 g/l, above all up to 6 g/l or up to 4 g/l.

in some situations it may be particularly preferable for the phosphating solution to contain at least 0.03 g/l of chloride, particularly preferably at least 0.05 g/l, very particularly preferably at least 0.08 g/l or at least 0,12 g/l, in particular in some situations at least 0.15 g/l, at least 0.2 g/l or even at least 0.25 g/l. It preferably contains up to 0.35 g/l of chloride, particularly preferably up to 0.25 g/l, very particularly preferably up to 0.2 g/l, in particular in some situations up to 0.15 g/l, above all up to 0.1 g/l or up to 0.08 g/l.

It is particularly preferable for the phosphating solution to contain at least 0.01 g/l of sulfate, particularly preferably at least 0.05 g/l, very particularly preferably at least 0.1 g/l or at least 0.15 g/l, in particular in some situations at least 0.3 gll, at least 0.5 g/l, at least 0.7 g/l or even at least 1 g/l. It preferably contains up to 3.5 g/l of sulfate, particularly preferably up to 2 g/l, very particularly preferably up to 1.5 g/l, in particular in some situations up to 1 g/l or up to 0.5 g/l.

An addition of nitrate may be advantageous here in order also to phosphate aluminium-rich surfaces by layer formation, that is to say with a phosphate layer which is not too thin. The addition e.g. of sodium, iron, manganese, nickel or/and zinc is also preferably effected at least partly via. nitrates because of their good water-solubility. On the other hand it is preferable to add no chloride or/and no sulfate to the phosphating bath. Certain contents of chloride or/and sulfate are often already present in the water and can easily be carried in from other process sections.

In the phosphating process according to the invention, the contents in the phosphating solution of dissolved aluminium, including complexed aluminium, can preferably be 0.002 to 1 g/l.

Since in many cases a content. of dissolved aluminium acts as a bath poison, in these situations it will be preferable for not more than 0.03 g/l of dissolved aluminium to be present in the phosphating solution, especially during dipping, although in some processes, such as e.g, in spraying, up to 0.1 g/l of aluminium can be dissolved, and in no-rinse processes, such as e.g. during roiling on, even up to about 1 g/l of aluminium can be dissolved. It is therefore often advantageous if not more than 0.8 g/l, 0.5 g/l, 0.3 g/l, 0.1 g/l, 0.08 g/l, 0.06 g/l or not more than 0.34 g/l of aluminium occurs in the phosphating solution. It is particularly preferable if the contents of dissolved aluminium are virtually zero or zero or make up only low contents. It is also particularly preferable not to add aluminium intentionally, However, In the phosphating of aluminium or aluminium-containing metallic surfaces, a certain. content of aluminium in the phosphating bath is scarcely avoidable because of the pickling effect. The content of dissolved alumum, however, is advantageously limited by addition e.g. of at least one alkali metal compound or/and ammonium and of simple fluoride, such as e.g. by hydrofluoric acid or/and airmtonium hydrogen fluoride. In particular, it is preferable to precipitate out by this means cryolite Na₃AlF₆ and related aluminium-rich fluorine compounds, such as e.g. elpasolite, K₂NaAlF₆, since they have a very low solubility in water. Somewhat increased contents of dissolved aluminium can already have a troublesome effect on steel surfaces in particular, e.g. by preventing the formation of a layer, and should therefore he avoided. Alternatively, mixtures of at least one further ion chosen from at least one further type of alkali metal ions or/and ammonium ions, in addition to sodium ions, can also readily be employed.

The phosphatind solution preferably contains magnesium with a content of not more than 1 g/l or not more than 0.5 g/l, particularly preferably of not more than 0.15 g/l. Preferably, no calcium is added in the case of fluoride-containing phosphating systems.

In the phosphating process according to the invention, the contents in the phosphating solution of copper can he 0.002 to 0.05 g/l. The copper content of the phosphating solution is preferably not more than 0.03 g/l, particularly preferably not more than 0.015 g/l, in particular not more than 0.01 g/l. Preferably, however, copper is only added if there are low or no contents of nickel in the phosphating solution. Particularly preferably, however, no copper is added intentionally. Copper contents may be advantageous in individual situations, in particular in the case of iron-based materials. Some of or the total content of cobalt and copper, however, can also originate from impurities, entrained material or superficial pickling of the metallic surfaces of assemblies or pipelines. The contents of cobalt are also preferably below 0.05 g/l. Particularly preferably, no cobalt is to be added.

In the phosphating process according to the invention, the contents in the phosphating solution of free fluoride can be preferably 0.005 to 1 g/l or/and of total fluoride preferably 0.005 to 6 g/l. Free fluoride occurs in the bath solution as F⁻, while total fluoride can additionally also include contents of HF and all complex fluorides.

It is particularly preferable for the phosphating solution to contain at least 0.01 g/l of free fluoride, particularly preferably at least 0.05 g/l, very particularly preferably at least 0.01 g/l or at least 0.03 g/l, in particular in some situations at least 0.05 g/l, at least 0.08 g/l, at least 0.1 g/l, at least 0.14 g/l or even at least 0.18 g/l. It preferably contains up to 0.8 g/l of free fluoride, particularly preferably up to 0.6 g/l, very particularly preferably up to 0.4 g/l, in particular in some situations up to 0.3 g/l or up to 0.25 g/l.

It is particularly preferable for the phosphating solution to contain at least 0.01 g/l of total fluoride, particularly preferably at least 0.1 g/l, very particularly preferably at least 0.3 g/l or at least 0.6 g/l, in particular in some situations at least 0.9 g/l, at least 0.5 g/l, at least 0.8 g/l, at least 1 g/l or even at least 1.2 g/l. It preferably contains up to 5 g/l of total fluoride, particularly preferably up to 4 g/l, very particularly preferably up to 3 g/l, in particular in some situations up to 2.5 g/l or up to 2 g/l.

In the phosphating process according to the invention, the contents in the phosphating solution of complex fluoride in total can be 0.005 to 5 g/l—in particular HeF₄ or/and MeF₆, where it is to be taken into account that x in MeFₓ in principle can assume all values between 1 and 6, calculated as MeF₆−of Me=B, Si, Ti, Hf or/and Zr. Complex fluorides of Ti, Hf and Zr can act as bath poisons at higher contents since they can prematurely passivate the surface. It is therefore preferable for the total of complex fluorides of Ti, Hf and Zr to be not more than 0.8 g/l, particularly preferably not more than 0.5 g/l, very particularly preferably not more than 0.3 g/l, in particular not more than 0.15 g/l. It is therefore preferable if only complex fluorides of B or/and Si are present in the phosphating bath in a larger amount. In some cases only complex fluorides of B or Si are present in the phosphating bath in a larger amount, where it may be advantageous to use both side by side because they have slightly different properties. The addition of complex fluoride is particularly advantageous in the coating of zinc-containing surfaces, because the tendency to form specks (troublesome white spots) can be successfully suppressed by this means, in particular if at least 0.5 g/l of complex fluoride is added, An addition of silicofluoride is favourable in particular for preventing specks. Complex fluorides of boron and silicon moreover have the advantage that they display a buffer action in relation to free fluoride, so that with a suitable content of such complex fluorides it is possible to intercept a brief increase in the content of aluminium-containing objects, such as e.g. an aluminium-rich vehicle body, between galvanized vehicle bodies by an increased formation of free fluoride, without the bath having to be adapted to this changed consumption in the individual case.

In the phosphating process according to the invention, the contents in. the phosphatinq solution of silicofluoride, calculated as SiF₆, can be 0.005 to 4.5 g/l or/and of boron fluoride, calculated as 0.005 to 4.5 g/l, It is preferable for the contents in the phosphatinq solution of complex fluoride of B and Si in total, where complex fluoride is added, to be in the range from 0.005 to 5 g/l, particularly preferably in the range from 0.1 to 4.5 grip very particularly preferably in the range from 0.2 to 4 g/l, in particular in the range from 0.3 to 3.5 g/l. A total content of such complex. fluorides can then be, for example, 0.5, 0.8, 1.0, 1.2, 1.4, 1.6, 1.8, 2.0, 2.4, 2.8 or 3.2 g/l.

If complex fluoride is added, it is particularly preferable for the phosphating solution to contain at least 0.01 g/l of silicofluoride, particularly preferably at least 0.1 g/l, very particularly preferably at least 0.2 g/l or at least 0.3 g/l, in particular in some situations at least 0.4 g/l, at least 0.6 g/l, at least 0.8 g/l, at least 1 g/l or even at least 1.2 g/l. It preferably contains up to 4 g/l of silicofluoride, particularly preferably up to 3 g/l, very particularly preferably up to 2.5 g/l, in particular in some situations up to 2.2 g/l or up to 2 g/l, where complex fluoride is added.

If complex fluoride is added, it is particularly preferable for the phosphating solution to contain at least 0.01 g/l of boron fluoride, particularly preferably at least 0.1 g/l, very particularly preferably at least 0.2 g/l or at least 0.3 in particular in some situations at least 0.4 g/l, at least 0.6 g/l, at least 0.8 g/l, at least 1 g/l or even at least 1.2 g/l. It preferably contains up to 4 g/l of boron fluoride, particularly preferably up to 3 g/l, very particularly preferably up to 2.5 g/l, in particular in some situations up to 2.2 g/l or up to 2 g/l, where complex fluoride is added.

In the phosphating process according to the invention, the contents in the phosphating solution of titanium can be 0.01 to 2 g/l or/and of zirconium 0.01 to 2 g/l, The contents in the phosphating solution of titanium are particularly preferably not more than 1.5 g/l, very particularly preferably not more than 1 g/l, above all not more than 0.5 g/l, not more than 0.3 g/l or even not more than 0.1 g/l. The contents in the phosphating solution of zirconium are particularly preferably not more than 1.5 g/l, very particularly preferably not more than 1 g/l, above all not more than 0.5 g/l, not more than 0.3 g/l or even not more than 0.1 g/l, Contents of titanium or/and zirconium can be carried in via the liquids or attachments and other devices in particular if e.g. a titanium-containing activation or a. zirconium-containing after-rinsing solution is employed.

The phosphating solutions according to the invention here are preferably largely free or free from pickling inhibitors, such as e.g. di-n-butyl-thiourea, largely free or free from lubricants or/and have a, total surfactant content of less than 1 g/l, since these substances can impair the formation of the phosphate layer or can generate foam. In many cases they are largely free or free from cations, such as e.g. antimony, arsenic, cadmium, chromium or/and tin. There may indeed be special cases in which an addition of organic polymers is advantageous, but nevertheless the phosphating solutions according to the invention conventionally do not have a content of organic polymers of more than 0.8 g/l, including contents of surfactant (s) or/and oil (s) carried in.

In the phosphating process according to the invention, the phosphating solution can have a content of at least one water-soluble or/and water dispersible organic polymeric compound, such as e.g. at least one polyelectrolyte or/and at least one polyether, such as, for example, at least one polysaccharide. These polymers can help to make the sludge even somewhat softer and easier to remove, Their content is preferably 0.001 to 0.5 g/l, in particular 0.003 to 0.2 g/l, By the use of the accelerator combination according to the invention the amount of sludge indeed is not usually reduced, but the sludge consistency and its ease of removal are significantly improved compared with phosphating systems with only one of the accelerators nitroguanidine or hydrogen peroxide. Furthermore, the phosphating in the process according to the invention proceeds faster than with only hydrogen peroxide acceleration.

In the process according to the invention, the consistency of the sludge precipitated in particular in the phosphating bath is more favourable than when solely the accelerator hydrogen peroxide is used in the phosphating solution. By the use of the accelerator combination of auanidine compound(s)—hydrogen peroxide, smaller phosphate crystals are formed than with only hydrogen peroxide, so that the average edge length of the phosphate crystals is usually less than 10 μm. The crystals are in a looser accumulation. of fine small crystals and can therefore easily be removed from the bath tank and the lines. A passivation effect of the guanidine compound(s) evidently moreover has a positive effect here, In the experiments carried out, the sludge had about the same consistency as with the combination of guanidine compound(s)—hydrogen peroxide—nitrate/nitrite.

In the phosphating process according to the invention, the phosphating solution can contain
0.1 to 10 g/l of zinc,
optionally 0.1 to 10 g/l of manganese,
optionally 0.01 to 1.8 g/l of nickel,
0.025 to 70 g/l of sodium, potassium and ammonium together,
optionally 0.01 to 2 g/l of titanium or/and 0.01 to 2 g/l of zirconium,
4 to 50 g/l of phosphate, calculated as PO₄,
0.005 to 1 g/l of free fluoride,
0.005 to 6 g/l of total fluoride,
optionally 0.005 to 5 g/l of the total of complex fluorides of B, Si, Ti, Hf or/and Zr,
optionally 0.005 to 4.5 g/l of silicofluoride or/and 0.005 to 4.5 g/l of boron fluoride,
0.03 to 3 g/l of at least one guanidine compound which contains at least one nitro group, calculated as nitroguanidine,
0.001 to 0.2 g/l of hydrogen peroxide,
0.1 to 30 g/l of nitrate,
optionally 0.01 to 0.5 g/l of chloride,
optionally 0.005 to 5 g/l of sulfate and
optionally 0.001 to 0.5 g/l of at least one water-soluble or/and water-dispersible organic polymeric combound.

In the phosphating process according to the invention, the phosphating solution can contain
0.2 to 6 g/l of zinc,
optionally 0.1 to 5 g/l of manganese,
optionally 0.01 to 1.6 g/l of nickel,
0.025 to 40 g/l of sodium, potassium and ammonium together,
optionally 0.01 to 2 g/l of titanium or/and 0.01 to 2 g/l of zirconium,
5 to 45 g/l of phosphate, calculated as PO₄, 0.005 to 1 g/l of tree fluoride,
0.005 to 5 g/l of total fluoride,
optionally 0.005 to 4 g/l of the total of complex fluorides of B, Si, Ti, Hf or/and Zr,
optionally 0.005 to 3.6 g/l of silicofluoride or/and 0.005 to 3.6 g/l of boron fluoride,
0.03 to 2 g/l of at least one guanidine compound which contains at least one nitro group, calculated as nitroguanidine,
0.001 to 0.9 g/l of hydrogen peroxide,
0.1 to 20 g/l of nitrate,
optionally 0.01 to 0.5 g/l of chloride,
optionally 0.005 to 3 g/l of sulfate and
optionally 0.002 to 0.4 g/l of at least one water-soluble or/and water-dispersible organic polymeric compound.

To determine the free acid, KCl is added to saturation to 10 ml of the phosphating solution, without dilution, for the purpose of shifting the dissociation of the complex fluoride and titration is carried out with 0.1 M NaOH, using dimethyl yellow as the indicator, until the colour changes from red to yellow. The amount of 0.1 M NaOH consumed in ml gives the value of the free acid (FA-KCl) in points. However, if the phosphating solution contains no complex fluoride, the free acid is titrated in 100 ml of completely desalinated water with NaOH against dimethyl yellow as the indicator to the change from red to yellow. The amount of 0.1 M NaOH consumed in ml gives the value of the free acid (FA) in points.

To determine the total content of phosphate ions, 10 ml of the phosphating solution are diluted with 200 ml of completely desalinated water and titrated with 0.1 M NaOH, using bromocresol green as the indicator, until the colour changes from yellow to turquoise. After this titration and after addition of 20 ml 30% neutral potassium oxalate solution, titration is carried. out with 0.1 N NaOH against phenolphthalein as the indicator until the colour changes from blue to violet. The consumption of 0.1 M NaOH in ml between the change in colour with bromocresol green and the change in colour with phenolphthalein corresponds to the Fischer total acid (FTA) in points, This value multiplied by 0.71 gives the total content of phosphate ions in P₂O₅, or multiplied by 0.969 for PO₄ (see W. Rausch; “Die Phosphatierung von Metallen [Phosphating of metals]”, Eugen G. Leuze-Verlag 1988, pp. 300 et. seq.).

The so-called S value is obtained by dividing the value of the free acid KCl—or without the presence of complex fluoride in the phosphating solution—of the free acid by the value of the Fischer total acid.

The total acid diluted (TA_{diluted}) is the sum of the divalent cations and free and bonded phosphoric acids (the later are phosphates) contained in the solution. it is determined by the consumption of 0.1 molar sodium hydroxide solution, using the indicator phenolphthalein, by 10 ml of phosphating solution diluted with 200 ml of completely desalinated water. This consumption of 0.1 M NaOH in ml corresponds to the total acid points number, in the process according to the invention, the content of free acid KCl—or, without the presence of complex fluoride in the phosphating solution, the free acid—can be preferably in the range from 0.3 to 6 points, the content of total acid diluted preferably in the range from 8 to 70 points or/and the content of Fischer total acid preferably in. the range from 4 to 50 points. The range of the free acid KCl is preferably 0.4 to 5.5 points, in particular 0.6 to 5 points. The range of the total acid diluted is preferably 12 to 50 points, in particular 18 to 44 points. The range of the Fischer total acid is preferably 7 to 42 points, in particular 10 to 30 points. The S value as the ratio of the number of points of free acid KCl—or free acid—to that of the Fischer total acid is preferably in the range from 0.01 to 0.40, in particular in the range from 0.03 to 0.35, above all in the ranee from 0.05 to 0.30,

In the coating process according to the invention, the pH of the phosphating solution can be in the range from 1 to 4, preferably in the range from 2.2 to 3.6, particularly preferably in the range from 2.8 to 3.3.

In the phosphating process according to the invention, the metallic surfaces can be phosphated at a temperature in the range from 30 to 75° C., in particular at 35 to 60° C., particularly preferably at up to 55° C. or at up to 50° C. or at up to 48° C.

In the phosphating process according to the invention, the metallic surfaces—in particular during dipping or/and spraying—can be brought into contact with the phosphating solution over a period of time preferably in the range from 0.1 to 8 minutes, in particular over 0.2 to 5 minutes. In the case of rolling on or misting on using a belt, the contact time can be reduced to fractions of a second.

The phosphating solution according to the invention is suitable for the most diverse metallic surfaces, but in particular also for iron-based materials in the dipping process. On the other hand, it has been found that the process according to the invention is also particularly suitable for phosphating for a mix of objects from various metallic materials, in particular chosen from aluminium, aluminium alloy(s), steel/steels, galvanized steel/galvanized steels and zinc alloy(s). This process is also particularly suitable for a high throughput of aluminium-rich surfaces.

In the phosphating process according to the invention, the metallic surfaces can be cleaned, pickled or/and activated before the phosphating, in each case optionally with at least one subsequent rinsing step. Preferably, the last rinsing step of all after the phosphating and optionally after the after-rinsing is a rinsing operation with completely desalinated water.

In the phosphating process according to the invention, the phosphated metallic surfaces can then be rinsed, after-rinsed with an after-rinsing solution, dried or/and coated with in each case at least. one lacquer, one lacquer-like coating, one adhesive or/and one foil. The after-rinaing solution. can. be of quite different composition, depending on the profile of requirements. The compositions are known in principle to the expert.

The invention also relates to an acidic, aqueous solution which contains
0.1 to 1.0 g/l of zinc,
4 to 50 g/l of phosphate, calculated as PO₄,
0.03 to 3 g/l of at least one guanidine compound which contains at least one nitro group, calculated as nitroguanidine, and
0.001 to 0.9 g/l of hydrogen peroxide.

The acidic, aqueous solution according to the invention. can additionally also contain.
0.025 to 70 g/l of sodium, potassium and ammonium together,
0.005 to 1 g/l of free fluoride,
0005 to 6 g/l of total fluoride or/and
0.1 to 30 g/l of nitrate,

The acidic, aqueous solution according to the invention can additionally also contain
0.1 to 10 g/l of manganese,
0.01 to 1.8 g/l of nickel,
0.005 to 5 g/l of the total of complex fluorides of B, Si, Ti, Hf or/and Zr,
0,005 to 4.5 g/l of silicofluoride,
1.0-0.005 to 4.5 g/l of boron fluoride,
0.01 to 2 g/l of titanium,
0.01 to 2 g/l of zirconium,
001 to 0.5 g/l of chloride,
0.005 to 5 g/l of sulfate or/and
0.001 to 0.5 g/l of at least one water-soluble or/and water-dispersible organic polymeric compound.

The nickel content is preferably not more than 1.5 g/l,

The acidic, aqueous solution according to the invention. can be on the one hand a phosphating solution which is employed as a phosphating bath, and on the other hand optionally also the corresponding concentrate or the corresponding topping-up solution in order to prepare a phosphating solution by dilution or to keep the phosphating solution in the desired concentration level in respect of essential constituents using the topping-up solution.

The invention moreover also relates to a metallic object with a phosphate layer which has been prepared by the process according to the invention.

The objects coated according to the invention, can be used, for example, in vehicle construction, in particular in automobile series production, for the production of components or vehicle body components or pre-assembled elements in the vehicle or air travel industry, in the construction industry, in the furniture industry, for the production of equipment and installations, in particular domestic appliances, measuring instruments, control installations, test equipment, construction elements, linings and of hardware items.

It was surprising that with a significantly decreased concentration of additions of at least one guanidine compound, such as nitroguanidine, results of the same order as with systems accelerated solely with nitroguanidine were achieved, but it was possible in some cases to reduce the consumption of accelerators by up to 30% and it was possible to improve the environment friendliness further, since it was possible for the contents of ammonium, guanidine compounds, nitrate and nitrite and therefore the nitrogen load of the waste water to be lowered significantly.

In a phosphating system accelerated only with nitroguanidine and optionally nitrate, a layer weight. of 2.5 to 3.5 g/m² is often determined with closed layers and a good layer formation, as a result of which a comparatively high consumption occurs, With the process according to the invention, however, it has been possible to form phosphate layers which, at an average edge length of the phosphate crystals of the order of less than 10 μm, usually have a layer weight usually of the order of about 2 to 2.5 g/m² or, at an average edge length of the phosphate crystals of the order of about 6 μm, often. have a layer weight of the order of about 1.5 to 2 g/m², in particular also on steel. The quality of the corrosion resistance and the lacquer adhesion has not fallen by this means, The more fine-grained the phosphate layer is formed, the thinner the phosphate layer can be formed, This particularly thin phosphate layer can be formed less expensively and is of increased lacquer adhesion and of increased flexibility during shaping. Phosphate layers with an average edge length of the phosphate crystals of the order of about 5 μm at a layer weight of the order of about 1.5 g/m² can therefore be regarded approximately as the optimum.

It was furthermore surprising that it was possible to carry out the phosphating at temperatures 3 to 25° C. lower than usual and therefore less expensively without sacrificing process quality and layer quality. Instead of the typical phosphating temperature in the range from about 48 to 65° C. in the case of conventional phosphating solutions, according to the invention the phosphating can be carried out well or even very well here in the range from 30 to 65° C., in particular in the range from 35 to 55°. The lower the temperature, the lower the acidity of the bath can be kept, in particular the S value as the ratio of the free acid or the free acid KCl to the Fischer total acid,

### EXAMPLES AND COMPARISON EXAMPLES

The subject matter of the invention is explained in more detail with the aid of embodiment examples:

The examples are based on the substrates and process steps listed in the following:

The test metal sheets comprised a mix of metal sheets in each case in the ratio 1:1:1:1
A) of an aluminium alloy AlMg_{0.4}Si_{1.2} corresponding to AA6016,
B) of a cold-rolled continuously annealed steel sheet of unalloyed steel DC04B,
C) of fine metal sheet electrolytically galvanized on both sides, automobile quality, quality DX54 DZI00 and
D) of hot-galvanized rerolled metal sheet of soft unalloyed steel of quality DX53 with a zinc deposit of at least 100 g/m²,
in each case with a thickness of approx. 0.75 mm. The surface area of each individual metal sheet, of which in each case at least 3 metal sheets were employed per composition, type of metal sheet and experiment, was 400 cm², measured over both surfaces.

1. The substrate surfaces were cleaned in a 2% aqueous solution of a mildly alkaline cleaner for 5 minutes at 58 to 60° C. and thereby thoroughly decreased.

2. Rinsing with tap water for 0.5 minute at room temperature followed.

3. The surfaces were then. activated by dipping in an activating agent containing titanium phosphate for 0.5 minute at room temperature.

4. Thereafter, the surfaces were phosphated by dipping in the phosphating solution for 3 minutes at 53 or 45° C.

The phosphating temperature had already been determined in preliminary experiments.

5. Rinsing was then first carried out with tap water, after-rinsing was subsequently carried out with an aqueous solution containing zirconium fluoride, and finally rinsing was carried out with completely desalinated water.

6. The coated substrates were then dried in a drying oven at 80° C. for 10 minutes, The layer weight was also determined in this state.

7. Finally, the dry test metal sheets were provided with a cathodic dipcoating and coated with the further layers of a conventional lacquer build-up for vehicle bodies in the automobile industry.

The compositions of the particular phosphating solutions are listed in table 1.

TABLE 1
Composition of the phosphating solutions in g/l and with the acidity data in points

| Examples | | | | | | | | |
|---|---|---|---|---|---|---|---|---|
| Contents | | | | | | | | |
| in g/l | CE 1 | CE 2 | CE 3 | CE 4 | CE 5 | E 6 | E 7 | E 8 |
| Zn | 1.2 | 1.2 | 1.2 | 1.2 | 1.2 | 1.2 | 1.2 | 1.2 |
| Ni | 0.8 | 0.8 | 0.8 | 0.8 | 0.8 | 0.8 | 0.8 | 0.8 |
| Mn | 0.8 | 0.8 | 0.8 | 0.8 | 0.8 | 0.8 | 0.8 | 0.8 |
| PO₄ | 17.4 | 17.4 | 17.4 | 17.4 | 17.4 | 17.4 | 17.4 | 17.4 |
| NO₃ | 2 | 2 | 2 | 2 | 2 | 2 | — | 2 |
| SiF₆ | — | — | — | — | — | — | — | 1.5 |
| F free | — | — | — | — | — | — | — | 0.045 |
| F total | — | — | — | — | — | — | — | 1.3 |
| Nitro- | 0.8 | 0.2 | — | — | — | 0.25 | 0.25 | 0.25 |
| guanidine | | | | | | | | |
| H₂O₂ | — | — | 0.025 | 0.008 | — | 0.008 | 0.008 | 0.008 |
| FA or FA- | 0.9 | 0.9 | 0.9 | 0.9 | 0.9 | 0.9 | 0.9 | 0.9 |
| KCl | | | | | | | | |
| TA_{dilute} | 22.3 | 22 | 22.5 | 22.4 | 22.8 | 22.5 | 22.5 | 27.5 |
| FTA | 18.3 | 18.3 | 18.3 | 18.3 | 18.3 | 18.3 | 18.3 | 18.3 |
| S value | 0.05 | 0.05 | 0.05 | 0.05 | 0.05 | 0.05 | 0.05 | 0.05 |
| Temperature | 53 | 53 | 53 | 53 | 53 | 45 | 45 | 45 |
| ° C. | | | | | | | | |
| Edge | 6 | 15 | 12 | 20 | 35 | 6 | 6 | 6 |
| length⁺) | | | | | | | | |

Layer weight in g/m² on:

| Steel | 2.8 | * | 1.7 | * | * | 1.8 | 2.3 | 2.0 |
|---|---|---|---|---|---|---|---|---|
| El. galv. | 3 | 5 | 3.2 | 4.6 | 4.7 | 2.8 | 3.3 | 3.5 |
| steel | | | | | | | | |
| Hot-galv. | 1.9 | 3 | 2.6 | 3.5 | 3.1 | 3.1 | 3.6 | 2.8 |
| steel | | | | | | | | |
| Aluminium | — | — | — | — | — | — | — | 0.5* |
| all. | | | | | | | | |
| Examples | | | | | | | | |
| Contents | | | | | | | | |
| in g/l | E 9 | E 10 | E 11 | E 12 | E 13 | E 14 | E 15 | E 16 |
| Zn | 1.0 | 1.0 | 1.0 | 1.0 | 1.3 | 1.3 | 1.3 | 1.3 |
| Ni | 0.8 | 0.8 | — | — | 0.8 | 0.8 | — | — |
| Mn | 0.8 | 0.8 | 0.8 | 0.8 | 0.8 | 0.8 | 0.8 | 0.8 |
| PO₄ | 17.4 | 17.4 | 17.4 | 17.4 | 17.4 | 17.4 | 17.4 | 17.4 |
| NO₃ | 2 | 2 | 2 | 2 | 2 | 2 | 2 | 2 |
| SiF₆ | 1.5 | — | 1.5 | — | 1.5 | — | 1.5 | — |
| F free | 0.2 | — | 0.2 | — | 0.2 | — | 0.2 | — |
| F total | 1.8 | — | 1.8 | — | 1.8 | — | 1.8 | — |
| Nitro- | 0.25 | 0.25 | 0.25 | 0.25 | 0.25 | 0.25 | 0.25 | 0.25 |
| guanidine | | | | | | | | |
| H₂O₂ | 0.008 | 0.008 | 0.008 | 0.008 | 0.008 | 0.008 | 0.008 | 0.008 |
| FA or FA- | 0.9 | 0.9 | 0.9 | 0.9 | 0.9 | 0.9 | 0.9 | 0.9 |
| KCl | | | | | | | | |
| TA_{dilute} | 27.8 | 21.8 | 27.6 | 21.5 | 27.9 | 21.3 | 27.4 | 21.8 |
| FTA | 18.3 | 18.3 | 18.3 | 18.3 | 18.3 | 18.3 | 18.3 | 18.3 |
| S value | 0.05 | 0.05 | 0.05 | 0.05 | 0.05 | 0.05 | 0.05 | 0.05 |
| Temperature | 45 | 45 | 45 | 45 | 45 | 45 | 45 | 45 |
| ° C. | | | | | | | | |
| Edge | 6 | 6 | 6 | 6 | 6 | 6 | 6 | 6 |
| length⁺) | | | | | | | | |

Layer weight in g/m² on:

| | | | | | | | | |
|---|---|---|---|---|---|---|---|---|
| Steel | 1.9 | 2.2 | 2.0 | 1.9 | 2.1 | 2.2 | 2.0 | 2.1 |
| El. galv. | 3.6 | 3.3 | 3.5 | 3.0 | 3.1 | 3.2 | 3.3 | 3.4 |
| steel | | | | | | | | |
| Hot-galv. | 2.9 | 2.5 | 2.7 | 2.6 | 2.8 | 2.9 | 2.7 | 2.6 |
| steel | | | | | | | | |
| Aluminium | 2.9 | — | 3.2 | — | 3.1 | — | 3.2 | — |
| all. | | | | | | | | |

| Examples | | | | | | | | | |
|---|---|---|---|---|---|---|---|---|---|
| Contents | | | | | | | | | |
| in g/l | E 17 | E 18 | E 19 | E 20 | E 21 | E 22 | E 23 | E 24 | E 25 |
| Zn | 1.8 | 2.5 | 4.5 | 9.0 | 1.5 | 1.5 | 1.5 | 1.5 | 1.5 |
| Ni | 0.8 | 1.0 | 1.2 | 1.5 | — | — | 0.2 | 0.5 | 1.5 |
| Mn | 0.8 | 1.0 | 1.2 | 1.5 | 0.8 | 2.5 | 0.8 | 0.8 | 0.8 |
| PO₄ | 17.4 | 17.4 | 25.0 | 40.0 | 17.4 | 17.4 | 17.4 | 17.4 | 17.4 |
| NO₃ | 2 | 2 | 2 | 2 | 2 | 2 | 2 | 2 | 2 |
| SiF₆ | 1.5 | 1.5 | 1.5 | 1.5 | 1.5 | 1.5 | 1.5 | 1.5 | 1.5 |
| BF₄ | — | — | — | — | — | — | — | — | — |
| F free | 0.2 | 0.2 | 0.2 | 0.2 | 0.2 | 0.2 | 0.2 | 0.2 | 0.2 |
| F total | 1.8 | 1.8 | 1.8 | 1.8 | 1.8 | 1.8 | 1.8 | 1.8 | 1.8 |
| Nitro- | 0.25 | 0.25 | 0.25 | 0.25 | 0.25 | 0.25 | 0.25 | 0.25 | 0.25 |
| guanidine | | | | | | | | | |
| H₂O₂ | 0.008 | 0.008 | 0.008 | 0.008 | 0.008 | 0.008 | 0.008 | 0.008 | 0.008 |
| Temperature | 45 | 45 | 45 | 45 | 45 | 45 | 45 | 45 | 45 |
| ° C. | | | | | | | | | |
| Edge | 6 | 6 | 6 | 6 | 6 | 6 | 6 | 6 | 6 |
| length⁺) | | | | | | | | | |

| Examples | | | | | | | | |
|---|---|---|---|---|---|---|---|---|
| Contents | | | | | | | | |
| in g/l | E 26 | E 27 | E 28 | E 29 | E 30 | E 31 | E 32 | E 33 |
| Zn | 1.5 | 1.3 | 1.3 | 1.3 | 1.3 | 1.3 | 1.3 | 1.3 |
| Ni | 1.5 | 0.8 | 0.8 | 0.8 | 0.8 | 0.8 | 0.8 | 0.8 |
| Mn | 2.5 | 0.8 | 0.8 | 0.8 | 0.8 | 0.8 | 0.8 | 0.8 |
| PO₄ | 17.4 | 17.4 | 17.4 | 17.4 | 17.4 | 17.4 | 17.4 | 17.4 |
| NO₃ | 2 | 2 | 2 | 2 | 2 | 2 | 2 | 2 |
| SiF₆ | 1.5 | 0.5 | — | 1.0 | 1.5 | 1.5 | 1.5 | 1.5 |
| BF₄ | — | 1.0 | 1.5 | 0.5 | — | — | — | — |
| F free | 0.2 | 0.2 | 0.2 | 0.2 | 0.2 | 0.2 | 0.2 | 0.2 |
| F total | 1.8 | 1.9 | 2.0 | 1.9 | 1.8 | 1.8 | 1.8 | 1.8 |
| Nitro- | 0.25 | 0.25 | 0.25 | 0.25 | 0.1 | 0.25 | 0.4 | 0.25 |
| guanidine | | | | | | | | |
| H₂O₂ | 0.008 | 0.008 | 0.008 | 0.008 | 0.008 | 0.008 | 0.008 | 0.025 |
| Temperature | 45 | 45 | 45 | 45 | 45 | 45 | 45 | 45 |
| ° C. | | | | | | | | |
| Edge | 6 | 6 | 6 | 6 | 10 | 6 | 4 | 6 |
| length⁺) | | | | | | | | |

*no closed phosphate layer
⁺)average edge length of the phosphate crystals under an SEM in μm

Since the comparison examples and examples 1 to 7 contained neither a content of fluoride nor of complex fluoride, it was not possible to deposit visible phosphate layers on aluminium layers. It was therefore also not possible to determine a layer weight, In all the other experiments well-closed phosphate layers were formed. The minimum phosphating time necessary to just form a closed phosphate layer on steel. surfaces in the comparison examples was 2 minutes in CE1, 2.5 to 3 minutes in CE2 and CE3, 4 to 5 minutes in CE4 and about 15 minutes in CE5. However, in all the examples according to the invention it was as a rule 1.5 to 2 minutes on steel surfaces. It was therefore possible to lower it significantly. In contrast, the minimum phosphating time on aluminium. was generally somewhat lower, and on zinc-rich surfaces it was significantly lower. The average edge length of the phosphate crystals on steel surfaces was estimated approximately on 20 to 50 crystals on SEM photographs.

In the comparison examples 1 to 5, a closed phosphate layer was formed on steel surfaces only if a sufficient amount of accelerator was present. The content of nitroguanidine or hydrogen peroxide had been sufficient to form a closed phosphate layer only in comparison examples 1 and 3.

In comparison examples 1 to 5, however, on iron-rich surfaces, such as e.g. steel surfaces, it was possible to form a closed phosphate layer only if a particularly high concentration of an accelerator was chosen. However, if both nitroguanidine and hydrogen peroxide were present as accelerators, significantly lower accelerator contents, also in the total of these accelerators, were already sufficient for a good layer formation. Examples 6 et seq. according to the invention demonstrate that only 0,008 g/l of hydrogen peroxide in combination with 0.25 g/l of nitroquanidine was already sufficient for good results. With this accelerator combination it was therefore possible for the addition of accelerator to be lowered. and the process to be carried out less expensively, especially since nitroguanidine is the most expensive raw material component of the phosphating solution.

The additions or contents of sodium, potassium and ammonium resulted on the one hand from the impurities, in particular of the water, and on the other hand from the adjustment of the free acid or the S value, sodium hydroxide solution or/and ammonia solution being used if required. Contents of sodium of up to 3.6 g/l, of potassium of up to 0.05 g/l and of ammonium of up to 3.0 g/l were established here.

In addition, no aluminium, no calcium, no magnesium and no iron was added intentionally, Such contents in the phosphating solution resulted because of trace impurities in the water and the additions and because of the pickling effect on the surfaces of the metal sheets. For dissolved aluminium in the phosphating solution, a content in the range of a few mg/l resulted here, depending on the sample. No disturbances to the phosphating occurred here, Only a minimal content in the phosphating solution of dissolved iron(II) ions resulted because of the composition of the phosphating solution, since hydrogen peroxide led to an immediate precipitating out of the dissolved iron. Nitroguanidine was added to the phosphating solution as an accelerator with a content in the range from 0.1 to 0.5 g/l, hydrogen peroxide in the range from 0.005 to 0.05 g/l. Since hydrogen peroxide was consumed rapidly, hydrogen peroxide was topped up discontinuously. Fluorides and phosphates of Al, Fe, Zn and where appropriate other cations were found in the so-called “sludge”. However, practically nothing of these precipitation products was deposited on the metal sheet surfaces.

In the phosphating baths according to the invention, the sludae was easy to remove from the wall of the tank and lines without pressure jets and without a mechanical action because of its finely crystalline loose consistency.

A good quality of the coating was retained in these experiments in spite of a significant variation in the chemical composition of the phosphating solution within wide ranges. The phosphating solutions according to the invention therefore offered a further possibility also to coat a metal mix which has low or also high contents of aluminium-containing surfaces in a simple, reliable, robust, good, inexpensive and fast manner.

The phosphate layers of the examples according to the invention were finely crystalline and closed. Their corrosion resistance and adhesive strength corresponded to typical quality standards of similar zinc phosphate layers.

The studies carried out on the lacquered steel, sheets led to the following results.

TABLE 2
Results of the corrosion protection and lacquer adhesion studies
on lacquered steel sheets (* after the damp heat constant
atmosphere test over 240 h in accordance with DIN 50017 KK):

| | | Corrosion | Lacquer | | |
|---|---|---|---|---|---|
| | | after 10 | adhesion | | |
| | Corrosion | rounds salt | after 10 | | |
| | after 12 | spray | rounds | Lacquer | |
| | months | condensation | stone | adhesion: | |
| | open-air | water | chip | damage in the | |
| | weathering | alternating | test | cross-hatch | |
| | acc. To | test acc. | acc. To | test according | |
| | VDA 621- | To VDA 621- | DIN | to DIN EN ISO | |
| | 414 | 415 | 55996-1 | 2409 | |
| | Under- | Under- | Flaking of | Flaking rating | |
| | migration | migration | lacquer | | KK |
| | mm | mm | Rating | Start | test* |
| CE 1 | U < 1 | U 1.5 | 1.0 | Gt 0 | Gt 1 |
| CE 2 | U 3 | U 3.5 | 2.0 | Gt 1 | Gt 2 |
| CE 3 | U < 1 | U 1.0 | 1.0 | Gt 0 | Gt 1 |
| CE 4 | U 3 | U 2.5 | 2.0 | Gt 1 | Gt 2 |
| CE 5 | U 4 | U 5.0 | 3.0 | Gt 2 | Gt 4 |
| E 9 | U < 1 | U 1.0 | 0.5 | Gt 0 | Gt 1 |
| E 10 | U < 1 | U 1.0 | 1.0 | Gt 0 | Gt 1 |
| E 12 | U 2 | U 2.5 | 2.0 | Gt 1 | Gt 1 |
| E 22 | U 1 | U 2.0 | 2.0 | Gt 0 | Gt 1 |

Values of the under-migration up to U 2 mm in open-air weathering and up to U 2.0 mm and up to rating 2 in the stone chip test, the lacquer flaking up to 10% and the cross-hatch rating up to Gt 1 can be regarded as sufficiently good The ratings of the lacquer adhesion can vary between 0 and 5, 0 being the best rating.

The phosphate layers produced. according to the Invention look—in particular on steel surfaces—more uniform and more attractive than those of the comparison examples. Scanning electron microscope photographs demonstrated that the phosphate crystals have average edge lengths in the range below 15 μm, and in some cases even not more than 8 μm. Under 8 μm, the phosphate crystals were substantially isometric as substantially tabular.

Scanning electron microscope bhotographs with perpendicular or angled observation of the phosphated steel surfaces were chosen here. Steel surfaces in particular normally rather present problems in the phosohatina quality, In spite of a more sparing addition of accelerator, on the basis of the accelerator combination of nitroguanidine/hydrogen-peroxide a further improvement in respect of the uniformity and improved fine-grained structure of the phosphate layer compared with systems accelerated with only hydrogen peroxide or only nitroguanidine, where the comparison systems can also contain nitrate, was also found on steel surfaces. It was found that the system with the accelerator combination according to the invention was to be operated astonishingly more robustly than the phosphating systems with only hydrogen peroxide or with only nitroguanidine.

In the experiments with hydrogen-peroxide-accelerated phosphating systems according to the invention, it was possible reliably to maintain an average edge length of the phosphate crystals of less than 10 μm,

Moreover, it was astonishing that it was possible to lower the optimized phosphating temperature in dipping by about 8 to 10° C. compared with the phosphating systems with only hydrogen peroxide or with only nitroguanidine, without a loss in quality in the handling of the system and the coatings occurring. It should therefore be possible, without problems, to use this accelerator combination at temperatures in the ranae from 40 to 60° C. in the dipping or/and spraying process, and also in the rolling-on process. Temperatures in the range above 50° C. are conventionally required for phosphating systems only with hydrogen peroxide or only with nitroauanidine, since the phosphate layers otherwise cannot be formed to a sufficiently closed extent. The lowering of the temperature also led to a noticeable saving in costs.

Over a dipping time of up to 3 minutes, it was possible for all the substrates investigated to be coated well with a fine-grained and closed phosphate layer. The process was found here to he exceptionally robust, since widely varying contents of one or other of the types of metal sheet presented no problems at all. Furthermore, it was possible to lower the temperature of the phosphating solution.

1-26. (canceled)

27. A process for the treatment or pretreatment of surfaces of metallic objects with an acidic, aqueous solution consists essentially of
0.3 to 4 g/L of zinc,
5 to 24 g/L of phosphate, calculated as PO₄,
0.1 to 0.4 g/L of at least one guanidine compound which contains at least one nitro group, calculated as nitroguanidine, and
0.005 to 0.2 g/L of hydrogen peroxide,
0.01 to 1.8 g/L of nickel and has a temperature of less than 80° C., wherein in a first step no calcium or magnesium are intentionally added and wherein no copper is intentionally added, wherein the hydrogen peroxide is present in an amount of 0.0075 g/L, and wherein the contents in the phosphating solution of manganese are 0.2 to 2.5 g/L.

28. The process according to claim 27, wherein the phosphating solution has a content of Fe²⁺ of 0.005 to 1 g/L or of complexed Fe³ of from 0.005 to 0.5 g/L.

29. The process according to claim 27, wherein the contents in the phosphating solution of sodium are 0.04 to 20 g/L, of potassium 0.025 to 35 g/L, or of ammonium 0.01 to 50 g/L, where the total of sodium, potassium and ammonium is from 0.025 to 70 g/L.

30. The process according to claim 27, wherein the contents in the phosphating solution of nitrate are 0.1 to 30 g/L, of chloride 0.01 to 0.5 g/L or of sulfate 0.005 to 5 g/L.

31. The process according to claim 27, wherein the contents in the phosphating solution of dissolved aluminum, including complexed aluminum, are 0.002 to 1 g/L.

32. The process according to claim 28, wherein the contents in the phosphating solution of dissolved aluminum, including complexed aluminum, are 0.002 to 1 g/L.

33. The process according to claim 27, wherein the phosphating solution has a content of free fluoride of from 0.005 to 1 g/L or of total fluoride of from 0.005 to 6 g/L.

34. The process according to claim 28, wherein the phosphating solution has a content of at least 0.001 g/L of a vvater-soluble or water-dispersible organic polymeric compound.

35. The process according to claim 28, wherein the phosphating solution contains
0.3 to 4 g/L of zinc,
optionally 0.2 to 2.5 g/L of manganese,
optionally 0.01 to 1.8 g/L of nickel,
0.025 to 70 g/L of sodium, potassium and ammonium together,
5 to 24 g/L of phosphate, calculated as PO₄,
0.005 to 1 g/L of free fluoride,
0.005 to 6 g/L of total fluoride,
0.1 to 0.4 g/L of at least one guanidine compound which contains at least one nitro group, calculated as nitroguanidine,
0.005 to 0.2 g/L of hydrogen peroxide,
0.1 to 30 g/L of nitrate,
optionally 0.01 to 0.5 g/L of chloride,
optionally 0.005 to 5 g/L of sulfate and
optionally 0.001 to 0.5 g/L of at least one water-soluble or water-dispersible organic polymeric compound.

36. The process according to claim 36, wherein the phosphating solution contains
0.3 to 64 g/L of zinc,
optionally 0.2 to 2.5 g/L of manganese,
optionally 0.01 to 1.6 g/L of nickel,
0.025 to 40 g/L of sodium, potassium and ammonium together,
5 to 24 g/L of phosphate, calculated as PO₄,
0.005 to 1 g/L of free fluoride,
0.005 to 5 g/L of total fluoride,
0.1 to 0.4 g/L of at least one guanidine compound which contains at least one nitro group, calculated as nitroguanidine,
0.05 to 0.2 g/L of hydrogen peroxide,
0.1 to 20 g/L of nitrate,
optionally 0.01 to 0.5 g/L of chloride,
optionally 0.005 to 3 g/L of sulfate and
optionally 0.002 to 0.4 g/L of at least one water-soluble or water-dispersible organic polymeric compound.

37. The process according to claim 27, wherein the S value as the ratio of the number of points of free acid KCl—or free acid—to the number of points of Fischer total acid is in the range from 0.01 to 0.40.

38. The process according to claim 27, wherein the metallic surfaces are phosphated at a temperature in the range from 30 to 75° C.

39. The process according to claim 27, wherein the metallic surface are brought into contact with the phosphating solution over a period of time in the range from 0.1 to 8 minutes.

40. The process according to claim 27, wherein the metallic surfaces of a mix of objects of different metallic materials chosen from aluminum, aluminum alloy, steel, galvanized steel and zinc alloy are phosphated.

41. The process according to claim 27, wherein the metallic surfaces are cleaned, pickled or activated, optionally in each case with a subsequent rinsing step, before the phosphating.

42. The process according to claim 27, wherein the phosphated metallic surfaces are then rinsed, after-rinsed with an after-rinsing solution, dried or coated with in each case at least one lacquer, one lacquer-like coating, one adhesive or one foil.

43. An acidic aqueous solution comprising
0.3 to 4 g/L of zinc,
5 to 24 g/L of phosphate, calculated as PO₄,
0.005 to 0.2 g/L of at least one guanidine compound which contains at least one nitro group, calculated as nitroguanidine,
and 0.001 to 0.9 g/L of hydrogen peroxide, wherein no copper is intentionally added.

44. The acidic, aqueous solution according to claim 43, further comprising
0.025 to 70 g/L of sodium, potassium and ammonium together,
0.005 to 1 g/L of free fluoride,
0.005 to 6 g/L of total fluoride, or
0.1 to 30 g/L of nitrate.

45. The acidic, aqueous solution according to claim 43, wherein it additionally also contains
0.2 to 2.5 g/L of manganese,
0.01 to 1.8 g/L of nickel,
0.005 to 5 g/L of the total of complex fluorides of B, Si, or both
0.01 to 0.5 g/L of chloride,
0.005 to 5 g/L of sulfate or
optionally 0.001 to 0.5 g/L of at least one water-soluble or water-dispersible organic polymeric compound.

46. A metallic object with a phosphate layer, which has been produced by the process according to claim 27.

47. The acidic, aqueous solution according to claim 46, containing no added calcium or magnesium.

48. The process of claim 27, wherein the acidic, aqueous solution further comprises a complex fluoride of boron.

49. A process for the treatment or pretreatment of a surface of a metallic object with an acidic, aqueous solution consisting essentially of:
0.1 to 10 g/L of zinc,
4 to 50 g/L of phosphate, calculated as PO₄,
0.03 to 3 g/L of at least one guanidine compound which contains at least one nitro group, calculated as nitroguanidine,
a complex fluoride of at least one of boron and silicon; and
0.001 to 0.9 g/L of hydrogen peroxide and has a temperature of less than 80° C., wherein in a first step no calcium or magnesium are intentionally added and wherein no copper is intentionally added.

50. A process for the treatment or pretreatment of surfaces of metallic objects with an acidic, aqueous solution consisting of
0.3 to 4 g/L of zinc,
5 to 24 g/L of phosphate, calculated as PO₄,
0.1 to 0.4 g/L of at least one guanidine compound which contains at least one nitro group, calculated as nitroguani dine, and
0.005 to 0.2 g/L of hydrogen peroxide,
0.01 to 1.8 g/L of nickel
and has a temperature of less than 80° C., wherein in a first step no calcium or magnesium are intentionally added and wherein no copper is intentionally added.

51. The process according to claim 50, wherein the hydrogen peroxide is present in an amount of 0.006 g/L.

52. The process according to claim 51, wherein the hydrogen peroxide is present in an amount of 0.0075 g/L.

53. The process according to claim 50, wherein the hydrogen peroxide is present in an amount of 0.009 g/L.

54. The process according to claim 50, wherein the hydrogen peroxide is present in an amount of 0.011. g/L.

55. The process according to claim 27, wherein the hydrogen peroxide is present in an amount of 0.005 g/L.

56. The process according to claim 55, wherein the solution is nitrate free.

57. The process according to claim 55, wherein the solution contains 0.1 g/L nitrate.

58. The process according to claim 27, wherein the content of nitrate is greater than 5 g/L.

59. The process according to claim 27, wherein the content of nitrate is greater than 5 g/L.

60. The process according to claim 27, wherein the nitrate content is at least 6 g/L or at least 8 g/L.
